(19) United States
(12) Patent Application Publication
(10) Pub. No.: US 2026/0055830 A1
(43) Pub. Date: Feb. 26, 2026

(54) HYBRID PIPES

(71) Applicant: SAUDI WATER AUTHORITY, Riyadh (SA)

(72) Inventors: Nausha ASRAR, Riyadh (SA); Ali AL SAHARI, Riyadh (SA); Ghulam MUSTAFA, Riyadh (SA); Mohammed AL HAZMI, Riyadh (SA); Fatma AL RADHI, Riyadh (SA); Abdulrahman AL ANEZI, Riyadh (SA)

(21) Appl. No.: 19/306,046

(22) Filed: Aug. 21, 2025

Related U.S. Application Data
(60) Provisional application No. 63/685,461, filed on Aug. 21, 2024.

(51) Int. Cl. F16L 9/02

(52) U.S. Cl. CPC F16L 9/02

(57) ABSTRACT

Disclosed are pipes for transporting an aqueous solution including chloride, where the pipes comprise carbon steel and an inner lining coating an inner surface of the pipes, methods for transporting an aqueous solution including chloride with such pipes, and systems for transporting an aqueous solution including chloride with such pipes.

### CROSS-REFERENCE TO RELATED APPLICATIONS

This application claims the benefit of priority of U.S. Provisional Patent Application No. 63/685,461, filed Aug. 21, 2024, which is hereby incorporated by reference in its entirety.

### FIELD

The present disclosure relates to apparatuses, methods, and systems for hybrid pipes, which may be used in different industries and applications (e.g., in Seawater Reverse Osmosis (SWRO) plants).

### BACKGROUND

Presently pipelines used for high pressure SWRO desalination and brine mining process for minerals recovery employ expensive corrosion resistant alloys (CRAs), such as super duplex stainless steel (SDSS) pipes or other stainless steels with high pitting resistance equivalent numbers (PREN). These pipes are used because they can have high strength and ductility to avoid rupture at high pressures (e.g., above 4 MPa and in some instances 7 MPa and above, such as hoop stress), they can have a high structural integrity in a wide range of temperatures and UV light conditions, and they can have higher corrosion resistance to brine water, seawater, and high chloride content water than other pipes. However, SDSS materials and other CRAs are still subject to corrosion risks in an environment of high chloride levels and SDSS and other CRAs can have high costs, both of which can limit their use.

Previously, ethylene tetrafluoro ethylene (ETFE) and polyethylene (PE) pipes and linings have been used for transmission of industrial water, downhole applications, and chemicals, where resistance of polymer lining have been tested for corrosion due to seawater, downhole mud conditions, and erosion. Due to limited mechanical strength, ETFE and PE pipes may not be suitable to be used in high pressure lines under corrosive environment, such as for use in seawater desalination and/or brine mining for mineral recovery.

Therefore, industries need cost-effective alternatives of CRAs that can provide both corrosion resistance and high strength in an environment of extremely high chloride levels, low pH, and high fluid dynamics.

### BRIEF SUMMARY

A discovery has been made that provides a solution, disclosed herein, to at least one or more of the aforementioned problems. As an exemplary illustration, hybrid pipes, such as metal-nonmetal hybrid pipes (e.g., polymer lined carbon steel pipes), are developed for high pressure water and brine mining lines. For an exemplary hybrid pipe, its internal polymer lining provides high corrosion resistance (e.g., against chloride content in the range of 3 wt. % to 10 wt. %, with a pH range of 5 to 6), and its external carbon steel cover pipe can withstand hoop stress generated by the high-pressure fluid (e.g., above 7 MPa). Those exemplary hybrid pipes can lower the costs by replacing expensive super duplex stainless steel (SDSS) pipes in pipelines, such as in high pressure SWRO desalination and brine mining pipelines.

In an exemplary embodiment of this disclosure, a hybrid pipe of carbon steel lined with a suitable polymer is disclosed. The polymer lining of the hybrid pipe can provide protection from corrosion due to high content of chloride ions and other corrosive chemicals, such as strong acid and base. The carbon steel portion of the hybrid pipe can provide high strength to withstand the hoop stress fluid pressure at 8 MPa and above in SWRO and brine mining system.

Another exemplary embodiment of this disclosure discloses a hybrid pipe, made of carbon steel with inner lining of suitable polymer (e.g., ETFE and/or PE), and its use in seawater desalination and brine mining. The hybrid pipes can provide at least the following exemplary benefits: (1) high corrosion resistance against high and extremely high chloride levels (e.g., corrosion protection from chloride within the range of 3 wt. % to 10 wt. % and corrosion protection from HCl treated brine water of pH 5 to 6); (2) high strength for high pressure operation in SWRO water transmission lines (e.g., strength to combat the hoop stress generated at a pressure of 8 MPa); and (3) cost-effective approach where it is expected that the cost of hybrid pipelines will be 30-40% lower as compared to that of CRAs.

Disclosed includes embodiments of apparatuses, methods, and systems. In one aspect, disclosed is a method for transporting an aqueous solution, including contacting an aqueous solution comprising 3 wt. % or more chloride with an inner lining of a carbon steel pipe, where the inner lining includes ethylene tetrafluoro ethylene (ETFE) polymer and/or a polyethylene (PE) polymer, and/or where the inner lining coats and/or contacts an inner surface of the carbon steel pipe.

In some aspects, the inner lining includes polytetrafluoroethylene (PTFE) polymer, fluorinated ethylene propylene (FEP) polymer, perfluoroalkoxy alkanes (PFA) polymer, and/or other fluorine-based polymer(s).

In some aspects, the aqueous solution includes 3 wt. % to 20 wt. % chloride. In some aspects, the aqueous solution includes 3 wt. % to 15 wt. % chloride. In some aspects, the aqueous solution includes 3 wt. % to 10 wt. % chloride. In some aspects, the aqueous solution includes 3 wt. % to 5 wt. % chloride. In some aspects, the aqueous solution includes more than, less than, between, or equal to 3, 4, 5, 6, 7, 8, 9, 10, 11, 12, 13, 14, 15, 16, 17, 18, 19, or 20 wt. % chloride, or chloride of any percentage ranges in between the foregoing numbers.

In some aspects, the aqueous solution is acidic. In some aspects, the aqueous solution is neural or basic. In some aspects, the aqueous solution has a pH from 3 to 6.9. In some aspects, the aqueous solution has a pH from 4 to 6.5. In some aspects, the aqueous solution has a pH from 5 to 6. In some aspects, the aqueous solution has a pH of more than, less than, between, or equal to 0.1, 0.2, 0.3, 0.4, 0.5, 0.6, 0.7, 0.8, 0.9, 1, 2, 3, 4, 5, 6, 7, 8, 9, 10, 11, 12, 13, or 14, or a pH of any ranges in between the foregoing numbers.

In some aspects, the aqueous solution has a pressure of 4 MPa or above. In some aspects, the aqueous solution has a pressure of 0.1 MPa or above, 0.2 MPa or above, 0.3 MPa or above, 0.4 MPa or above, 0.5 MPa or above, 0.6 MPa or above, 0.7 MPa or above, 0.8 MPa or above, 0.9 MPa or above, 1 MPa or above, 1.1 MPa or above, 1.2 MPa or above, 1.3 MPa or above, 1.4 MPa or above, 1.5 MPa or above, 1.6 MPa or above, 1.7 MPa or above, 1.8 MPa or above, 1.9 MPa or above, 2.0 MPa or above, 2.1 MPa or above, 2.2 MPa or above, 2.3 MPa or above, 2.4 MPa or above, 2.5 MPa or above, 2.6 MPa or above, 2.7 MPa or above, 2.8 MPa or above, 2.9 MPa or above, 3.0 MPa or above, 3.1 MPa or above, 3.2 MPa or above, 3.3 MPa or above, 3.4 MPa or above, 3.5 MPa or above, 3.6 MPa or above, 3.7 MPa or above, 3.8 MPa or above, 3.9 MPa or above, 4.0 MPa or above, 4.1 MPa or above, 4.2 MPa or above, 4.3 MPa or above, 4.4 MPa or above, 4.5 MPa or above, 4.6 MPa or above, 4.7 MPa or above, 4.8 MPa or above, 4.9 MPa or above, 5.0 MPa or above, 5.1 MPa or above, 5.2 MPa or above, 5.3 MPa or above, 5.4 MPa or above, 5.5 MPa or above, 5.6 MPa or above, 5.7 MPa or above, 5.8 MPa or above, 5.9 MPa or above, 6.0 MPa or above, 6.1 MPa or above, 6.2 MPa or above, 6.3 MPa or above, 6.4 MPa or above, 6.5 MPa or above, 6.6 MPa or above, 6.7 MPa or above, 6.8 MPa or above, 6.9 MPa or above, 7.0 MPa or above, 7.1 MPa or above, 7.2 MPa or above, 7.3 MPa or above, 7.4 MPa or above, 7.5 MPa or above, 7.6 MPa or above, 7.7 MPa or above, 7.8 MPa or above, 7.9 MPa or above, 8.0 MPa or above, 8.1 MPa or above, 8.2 MPa or above, 8.3 MPa or above, 8.4 MPa or above, 8.5 MPa or above, 8.6 MPa or above, 8.7 MPa or above, 8.8 MPa or above, 8.9 MPa or above, 9.0 MPa or above, 9.1 MPa or above, 9.2 MPa or above, 9.3 MPa or above, 9.4 MPa or above, 9.5 MPa or above, 9.6 MPa or above, 9.7 MPa or above, 9.8 MPa or above, 9.9 MPa or above, or 10.0 MPa or above.

In some aspects, the aqueous solution includes seawater or brackish water that includes or has been treated to include 3 wt. % or more chloride. In some aspects, the aqueous solution includes seawater or brackish water that includes or has been treated to include 4 wt. % or more, 5 wt. % or more, 6 wt. % or more, 7 wt. % or more, 8 wt. % or more, 9 wt. % or more, 10 wt. % or more, 11 wt. % or more, 12 wt. % or more, 13 wt. % or more, 14 wt. % or more, 15 wt. % or more, 16 wt. % or more, 17 wt. % or more, 18 wt. % or more, 19 wt. % or more, 20 wt. % or more, 21 wt. % or more, 22 wt. % or more, 23 wt. % or more, 24 wt. % or more, or 25 wt. % or more chloride.

In some aspects, the inner lining has a thickness from 1.5 mm to 1 cm. In some aspects, the inner lining has a thickness from 0.1 mm to 3 cm. In some aspects, the inner lining has a thickness from 0.5 mm to 2 cm. In some aspects, the inner lining has a thickness from 1 mm to 1.5 cm. In some aspects, the inner lining has a thickness from 2 mm to 1 cm. In some aspects, the inner lining has a thickness from 3 mm to 9 mm. In some aspects, the inner lining has a thickness from 5 mm to 8 mm. In some aspects, the inner lining has a thickness from 3.5 mm to 5 mm. In some aspects, the inner lining has a thickness from 5 mm to 8 mm when the inner lining includes polyethylene (PE) polymer. In some aspects, the inner lining has a thickness from 3.5 mm to 5 mm when the inner lining includes ethylene tetrafluoro ethylene (ETFE) polymer.

In some aspects, the carbon steel pipe includes at least two openings, where i) a flange is secured to one opening of the at least two openings; or ii) the carbon steel pipe forms a flange. In some aspects, the carbon steel pipe includes two openings, where i) a flange is secured to each of the two openings; or ii) the carbon steel pipe forms a flange at each of the two openings.

In some aspects, the inner lining forms a protrusion ring at the flange. In some aspects, the protrusion ring includes a terminal portion of the inner lining that coats and/or contacts at least partially a surface of the flange. In some aspects, the protrusion ring is made of ethylene tetrafluoro ethylene (ETFE) polymer and/or polyethylene (PE) polymer.

In some aspects, the carbon steel pipe further includes a retainer ring outside the protrusion ring in a concentric manner. In some aspects, the retainer ring is made of a different material than the inner lining. In some aspects, the retainer ring is made of carbon steel.

In some aspects, at least one segment of the carbon steel pipe is curved. In some aspects, at least one segment of the carbon steel pipe is straight.

In some aspects, the carbon steel pipe has a diameter from about 0.6 to 107 cm. In some instances, the diameter is an inner diameter. In some aspects, the carbon steel pipe has a diameter from about 1.27 to 91 cm. In some aspects, the carbon steel pipe has a diameter from about 2.5 to 61 cm. In some aspects, the carbon steel pipe has a diameter from about 5 to 30 cm. In some aspects, the carbon steel pipe has a diameter of about 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 4, 5, 6, 8, 10, 12, 14, 16, 18, 20, 22, 24, 26, 28, 30, 32, 34, 36, 38, 40, 42, 44, 46, 48, 50, 52, 54, 56, 58, 60, 62, 64, 66, 68, 70, 72, 74, 76, 78, 80, 82, 84, 86, 88, 90, 92, 94, 96, 98, 100, 102, 104, 106, or 108 cm. In some aspects, the carbon steel pipe has a diameter of about 3.8 cm.

In one aspect, disclosed is a system for transporting an aqueous solution, the system including: a pipe including carbon steel and an inner lining coating an inner surface of the pipe, where the inner lining includes ethylene tetrafluoro ethylene (ETFE) polymer and/or a polyethylene (PE) polymer; and/or where a source of the aqueous solution including 3 wt. % or more chloride, the source being in fluid communication with the pipe.

In some aspects, the inner lining includes polytetrafluoroethylene (PTFE) polymer, fluorinated ethylene propylene (FEP) polymer, perfluoroalkoxy alkanes (PFA) polymer, and/or other fluorine-based polymer(s).

In some aspects, the aqueous solution includes 3 wt. % to 20 wt. % chloride. In some aspects, the aqueous solution includes 3 wt. % to 15 wt. % chloride. In some aspects, the aqueous solution includes 3 wt. % to 10 wt. % chloride. In some aspects, the aqueous solution includes 3 wt. % to 5 wt. % chloride. In some aspects, the aqueous solution includes any one of, greater than, less than, or between, 3, 4, 5, 6, 7, 8, 9, 10, 11, 12, 13, 14, 15, 16, 17, 18, 19, 20, 21, 22, 23, 24, or 25 wt. % chloride, or chloride of any percentage ranges in between the foregoing numbers.

In some aspects, the aqueous solution is acidic. In some aspects, the aqueous solution is neural or basic. In some aspects, the aqueous solution has a pH from 3 to 6.9. In some aspects, the aqueous solution has a pH from 4 to 6.5. In some aspects, the aqueous solution has a pH from 5 to 6. In some aspects, the aqueous solution has a pH of any one of, greater than, less than, or between 0.1, 0.2, 0.3, 0.4, 0.5, 0.6, 0.7, 0.8, 0.9, 1, 2, 3, 4, 5, 6, 7, 8, 9, 10, 11, 12, 13, or 14, or a pH of any ranges in between the foregoing numbers.

In some aspects, the aqueous solution has a pressure of 4 MPa or above. In some aspects, the aqueous solution has a pressure of 0.1 MPa or above, 0.2 MPa or above, 0.3 MPa or above, 0.4 MPa or above, 0.5 MPa or above, 0.6 MPa or above, 0.7 MPa or above, 0.8 MPa or above, 0.9 MPa or above, 1 MPa or above, 1.1 MPa or above, 1.2 MPa or above, 1.3 MPa or above, 1.4 MPa or above, 1.5 MPa or above, 1.6 MPa or above, 1.7 MPa or above, 1.8 MPa or above, 1.9 MPa or above, 2.0 MPa or above, 2.1 MPa or above, 2.2 MPa or above, 2.3 MPa or above, 2.4 MPa or above, 2.5 MPa or above, 2.6 MPa or above, 2.7 MPa or above, 2.8 MPa or above, 2.9 MPa or above, 3.0 MPa or above, 3.1 MPa or above, 3.2 MPa or above, 3.3 MPa or above, 3.4 MPa or above, 3.5 MPa or above, 3.6 MPa or above, 3.7 MPa or above, 3.8 MPa or above, 3.9 MPa or above, 4.0 MPa or above, 4.1 MPa or above, 4.2 MPa or above, 4.3 MPa or above, 4.4 MPa or above, 4.5 MPa or above, 4.6 MPa or above, 4.7 MPa or above, 4.8 MPa or above, 4.9 MPa or above, 5.0 MPa or above, 5.1 MPa or above, 5.2 MPa or above, 5.3 MPa or above, 5.4 MPa or above, 5.5 MPa or above, 5.6 MPa or above, 5.7 MPa or above, 5.8 MPa or above, 5.9 MPa or above, 6.0 MPa or above, 6.1 MPa or above, 6.2 MPa or above, 6.3 MPa or above, 6.4 MPa or above, 6.5 MPa or above, 6.6 MPa or above, 6.7 MPa or above, 6.8 MPa or above, 6.9 MPa or above, 7.0 MPa or above, 7.1 MPa or above, 7.2 MPa or above, 7.3 MPa or above, 7.4 MPa or above, 7.5 MPa or above, 7.6 MPa or above, 7.7 MPa or above, 7.8 MPa or above, 7.9 MPa or above, 8.0 MPa or above, 8.1 MPa or above, 8.2 MPa or above, 8.3 MPa or above, 8.4 MPa or above, 8.5 MPa or above, 8.6 MPa or above, 8.7 MPa or above, 8.8 MPa or above, 8.9 MPa or above, 9.0 MPa or above, 9.1 MPa or above, 9.2 MPa or above, 9.3 MPa or above, 9.4 MPa or above, 9.5 MPa or above, 9.6 MPa or above, 9.7 MPa or above, 9.8 MPa or above, 9.9 MPa or above, or 10.0 MPa or above.

In some aspects, the aqueous solution includes seawater or brackish water that includes or has been treated to include 3 wt. % or more chloride. In some aspects, the aqueous solution includes seawater or brackish water that includes or has been treated to include 0.1 wt. % or more, 0.2 wt. % or more, 0.3 wt. % or more, 0.4 wt. % or more, 0.5 wt. % or more, 0.6 wt. % or more, 0.7 wt. % or more, 0.8 wt. % or more, 0.9 wt. % or more, 1 wt. % or more, 2 wt. % or more, 3 wt. % or more, 4 wt. % or more, 5 wt. % or more, 6 wt. % or more, 7 wt. % or more, 8 wt. % or more, 9 wt. % or more, 10 wt. % or more, 11 wt. % or more, 12 wt. % or more, 13 wt. % or more, 14 wt. % or more, 15 wt. % or more, 16 wt. % or more, 17 wt. % or more, 18 wt. % or more, 19 wt. % or more, 20 wt. % or more, 21 wt. % or more, 22 wt. % or more, 23 wt. % or more, 24 wt. % or more, 25 wt. % or more chloride.

In some aspects, the inner lining has a thickness from 1.5 mm to 1 cm. In some aspects, the inner lining has a thickness from 0.1 mm to 3 cm. In some aspects, the inner lining has a thickness from 0.5 mm to 2 cm. In some aspects, the inner lining has a thickness from 1 mm to 1.5 cm. In some aspects, the inner lining has a thickness from 2 mm to 1 cm. In some aspects, the inner lining has a thickness from 3 mm to 9 mm. In some aspects, the inner lining has a thickness from 5 mm to 8 mm. In some aspects, the inner lining has a thickness from 3.5 mm to 5 mm. In some aspects, the inner lining has a thickness from 5 mm to 8 mm when the inner lining includes polyethylene (PE) polymer. In some aspects, the inner lining has a thickness from 3.5 mm to 5 mm when the inner lining includes ethylene tetrafluoro ethylene (ETFE) polymer.

In some aspects, the pipe includes at least two openings, where i) a flange is secured to one opening of the at least two openings; or ii) the pipe forms a flange. In some aspects, the carbon steel pipe includes two openings, where i) a flange is secured to each of the two openings; or ii) the carbon steel pipe forms a flange at each of the two openings.

In some aspects, the inner lining forms a protrusion ring at the flange. In some aspects, the protrusion ring includes a terminal portion of the inner lining that coats and/or contacts at least partially a surface of the flange. In some aspects, the protrusion ring is made of ethylene tetrafluoro ethylene (ETFE) polymer and/or polyethylene (PE) polymer.

In some aspects, the pipe further includes a retainer ring outside the protrusion ring in a concentric manner. In some aspects, the retainer ring is made of a different material than the inner lining. In some aspects, the retainer ring is made of carbon steel.

In some aspects, at least one segment of the pipe is curved. In some aspects, at least one segment of the pipe is straight.

In some aspects, the pipe has a diameter from about 0.6 to 107 cm. In some instances, the diameter is an inner diameter. In some aspects, the carbon steel pipe has a diameter from about 1.27 to 91 cm. In some aspects, the carbon steel pipe has a diameter from about 2.5 to 61 cm. In some aspects, the carbon steel pipe has a diameter from about 5 to 30 cm. In some aspects, the carbon steel pipe has a diameter of about 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 4, 5, 6, 8, 10, 12, 14, 16, 18, 20, 22, 24, 26, 28, 30, 32, 34, 36, 38, 40, 42, 44, 46, 48, 50, 52, 54, 56, 58, 60, 62, 64, 66, 68, 70, 72, 74, 76, 78, 80, 82, 84, 86, 88, 90, 92, 94, 96, 98, 100, 102, 104, 106, or 108 cm. In some aspects, the carbon steel pipe has a diameter of about 3.8 cm.

In one aspect, disclosed is a pipe for transporting an aqueous solution including 3 wt. % or more chloride, where the pipe includes carbon steel and an inner lining coating an inner surface of the pipe, and/or where the inner lining includes ethylene tetrafluoro ethylene (ETFE) polymer and/or a polyethylene (PE) polymer.

In some aspects, the inner lining includes polytetrafluoroethylene (PTFE) polymer, fluorinated ethylene propylene (FEP) polymer, perfluoroalkoxy alkanes (PFA) polymer, and/or other fluorine-based polymer(s).

In some aspects, the inner lining has a thickness from 1.5 mm to 1 cm. In some aspects, the inner lining has a thickness from 0.1 mm to 3 cm. In some aspects, the inner lining has a thickness from 0.5 mm to 2 cm. In some aspects, the inner lining has a thickness from 1 mm to 1.5 cm. In some aspects, the inner lining has a thickness from 2 mm to 1 cm. In some aspects, the inner lining has a thickness from 3 mm to 9 mm. In some aspects, the inner lining has a thickness from 5 mm to 8 mm. In some aspects, the inner lining has a thickness from 3.5 mm to 5 mm. In some aspects, the inner lining has a thickness from 5 mm to 8 mm when the inner lining includes polyethylene (PE) polymer. In some aspects, the inner lining has a thickness from 3.5 mm to 5 mm when the inner lining includes ethylene tetrafluoro ethylene (ETFE) polymer.

In some aspects, the pipe includes at least two openings, where i) a flange is secured to one opening of the at least two openings; or ii) the pipe forms a flange. In some aspects, the carbon steel pipe includes two openings, where i) a flange is secured to each of the two openings; or ii) the carbon steel pipe forms a flange at each of the two openings.

In some aspects, the inner lining forms a protrusion ring at the flange, where the protrusion ring includes a terminal portion of the inner lining that coats and/or contacts at least partially a surface of the flange. In some aspects, the protrusion ring is made of ethylene tetrafluoro ethylene (ETFE) polymer and/or polyethylene (PE) polymer.

In some aspects, the pipe further includes a retainer ring outside the protrusion ring in a concentric manner. In some aspects, the retainer ring is made of a different material than the inner lining. In some aspects, the retainer ring is made of carbon steel.

In some aspects, at least one segment of the pipe is curved. In some aspects, at least one segment of the pipe is straight.

In some aspects, the pipe has a diameter from about 0.6 to 107 cm. In some instances, the diameter is an inner diameter. In some aspects, the carbon steel pipe has a diameter from about 1.27 to 91 cm. In some aspects, the carbon steel pipe has a diameter from about 2.5 to 61 cm. In some aspects, the carbon steel pipe has a diameter from about 5 to 30 cm. In some aspects, the carbon steel pipe has a diameter of about 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 4, 5, 6, 8, 10, 12, 14, 16, 18, 20, 22, 24, 26, 28, 30, 32, 34, 36, 38, 40, 42, 44, 46, 48, 50, 52, 54, 56, 58, 60, 62, 64, 66, 68, 70, 72, 74, 76, 78, 80, 82, 84, 86, 88, 90, 92, 94, 96, 98, 100, 102, 104, 106, or 108 cm. In some aspects, the carbon steel pipe has a diameter of about 3.8 cm.

In some aspects, the aqueous solution including 3 wt. % or more chloride contacts the inner lining of the pipe.

In some aspects, the aqueous solution includes 3 wt. % to 20 wt. % chloride. In some aspects, the aqueous solution includes 3 wt. % to 15 wt. % chloride. In some aspects, the aqueous solution includes 3 wt. % to 10 wt. % chloride. In some aspects, the aqueous solution includes 3 wt. % to 5 wt. % chloride. In some aspects, the aqueous solution includes any one of, greater than, less than, or between 3, 4, 5, 6, 7, 8, 9, 10, 11, 12, 13, 14, 15, 16, 17, 18, 19, 20, 21, 22, 23, 24, or 25 wt. % chloride, or chloride of any percentage ranges in between the foregoing numbers.

In some aspects, the aqueous solution is acidic. In some aspects, the aqueous solution is neural or basic. In some aspects, the aqueous solution has a pH from 3 to 6.9. In some aspects, the aqueous solution has a pH from 4 to 6.5. In some aspects, the aqueous solution has a pH from 5 to 6. In some aspects, the aqueous solution has a pH of 0.1, 0.2, 0.3, 0.4, 0.5, 0.6, 0.7, 0.8, 0.9, 1, 2, 3, 4, 5, 6, 7, 8, 9, 10, 11, 12, 13, or 14, or a pH of any ranges in between the foregoing numbers.

In some aspects, the aqueous solution has a pressure of 4 MPa or above. In some aspects, the aqueous solution has a pressure of 0.1 MPa or above, 0.2 MPa or above, 0.3 MPa or above, 0.4 MPa or above, 0.5 MPa or above, 0.6 MPa or above, 0.7 MPa or above, 0.8 MPa or above, 0.9 MPa or above, 1 MPa or above, 1.1 MPa or above, 1.2 MPa or above, 1.3 MPa or above, 1.4 MPa or above, 1.5 MPa or above, 1.6 MPa or above, 1.7 MPa or above, 1.8 MPa or above, 1.9 MPa or above, 2.0 MPa or above, 2.1 MPa or above, 2.2 MPa or above, 2.3 MPa or above, 2.4 MPa or above, 2.5 MPa or above, 2.6 MPa or above, 2.7 MPa or above, 2.8 MPa or above, 2.9 MPa or above, 3.0 MPa or above, 3.1 MPa or above, 3.2 MPa or above, 3.3 MPa or above, 3.4 MPa or above, 3.5 MPa or above, 3.6 MPa or above, 3.7 MPa or above, 3.8 MPa or above, 3.9 MPa or above, 4.0 MPa or above, 4.1 MPa or above, 4.2 MPa or above, 4.3 MPa or above, 4.4 MPa or above, 4.5 MPa or above, 4.6 MPa or above, 4.7 MPa or above, 4.8 MPa or above, 4.9 MPa or above, 5.0 MPa or above, 5.1 MPa or above, 5.2 MPa or above, 5.3 MPa or above, 5.4 MPa or above, 5.5 MPa or above, 5.6 MPa or above, 5.7 MPa or above, 5.8 MPa or above, 5.9 MPa or above, 6.0 MPa or above, 6.1 MPa or above, 6.2 MPa or above, 6.3 MPa or above, 6.4 MPa or above, 6.5 MPa or above, 6.6 MPa or above, 6.7 MPa or above, 6.8 MPa or above, 6.9 MPa or above, 7.0 MPa or above, 7.1 MPa or above, 7.2 MPa or above, 7.3 MPa or above, 7.4 MPa or above, 7.5 MPa or above, 7.6 MPa or above, 7.7 MPa or above, 7.8 MPa or above, 7.9 MPa or above, 8.0 MPa or above, 8.1 MPa or above, 8.2 MPa or above, 8.3 MPa or above, 8.4 MPa or above, 8.5 MPa or above, 8.6 MPa or above, 8.7 MPa or above, 8.8 MPa or above, 8.9 MPa or above, 9.0 MPa or above, 9.1 MPa or above, 9.2 MPa or above, 9.3 MPa or above, 9.4 MPa or above, 9.5 MPa or above, 9.6 MPa or above, 9.7 MPa or above, 9.8 MPa or above, 9.9 MPa or above, or 10.0 MPa or above.

In some aspects, the aqueous solution includes seawater or brackish water that includes or has been treated to include 3 wt. % or more chloride. In some aspects, the aqueous solution includes seawater or brackish water that includes or has been treated to include 0.1 wt. % or more, 0.2 wt. % or more, 0.3 wt. % or more, 0.4 wt. % or more, 0.5 wt. % or more, 0.6 wt. % or more, 0.7 wt. % or more, 0.8 wt. % or more, 0.9 wt. % or more, 1 wt. % or more, 2 wt. % or more, 3 wt. % or more, 4 wt. % or more, 5 wt. % or more, 6 wt. % or more, 7 wt. % or more, 8 wt. % or more, 9 wt. % or more, 10 wt. % or more, 11 wt. % or more, 12 wt. % or more, 13 wt. % or more, 14 wt. % or more, 15 wt. % or more, 16 wt. % or more, 17 wt. % or more, 18 wt. % or more, 19 wt. % or more, 20 wt. % or more, 21 wt. % or more, 22 wt. % or more, 23 wt. % or more, 24 wt. % or more, or 25 wt. % or more chloride.

Also disclosed herein are the following 23 aspects.

Aspect 1 is a method for transporting an aqueous solution, the method comprising contacting an aqueous solution comprising 3 wt. % or more chloride with an inner lining of a carbon steel pipe, the inner lining comprising ethylene tetrafluoro ethylene polymer or a polyethylene polymer and the inner lining coating an inner surface of the carbon steel pipe.

Aspect 2 is the method of Aspect 1, wherein the aqueous solution comprises 3 wt. % to 20 wt. % chloride.

Aspect 3 is the method of Aspect 1 or 2, wherein the aqueous solution is acidic.

Aspect 4 is the method of Aspect 3, wherein the aqueous solution has a pH from 3 to 6.9.

Aspect 5 is the method of any one of Aspects 1 to 4, wherein the aqueous solution has a pressure of 4 MPa or above.

Aspect 6 is the method of any one of Aspects 1 to 5, wherein the aqueous solution comprises seawater or brackish water that comprises or has been treated to comprise 3 wt. % or more chloride.

Aspect 7 is the method of any one of Aspects 1 to 6, wherein the inner lining has a thickness from 1.5 mm to 1 cm.

Aspect 8 is the method of any one of Aspects 1 to 7, wherein the carbon steel pipe comprises at least two openings and wherein: i) a flange is secured to one opening of the at least two openings; and/or ii) the carbon steel pipe forms a flange.

Aspect 9 is the method of Aspect 8, wherein the inner lining forms a protrusion ring at the flange, wherein the protrusion ring comprises a terminal portion of the inner lining that coats and/or contacts at least partially a surface of the flange.

Aspect 10 is the method of Aspect 9, wherein the carbon steel pipe further comprises a retainer ring outside the protrusion ring in a concentric manner, wherein the retainer ring is made of a different material than the inner lining.

Aspect 11 is the method of any one of Aspects 1 to 10, wherein at least one segment of the carbon steel pipe is curved.

Aspect 12 is the method of any one of Aspects 1 to 11, wherein the carbon steel pipe has a diameter from about 0.6 to 107 cm.

Aspect 13 is a system for transporting an aqueous solution, the system comprising: a pipe comprising carbon steel and an inner lining coating an inner surface of the pipe, the inner lining comprising ethylene tetrafluoro ethylene polymer or a polyethylene polymer; and a source of the aqueous solution comprising 3 wt. % or more chloride, the source being in fluid communication with the pipe.

Aspect 14 is a pipe for transporting an aqueous solution comprising 3 wt. % or more chloride, the pipe comprising carbon steel and an inner lining coating an inner surface of the pipe, the inner lining comprising ethylene tetrafluoro ethylene polymer or a polyethylene polymer.

Aspect 15 is the pipe of Aspect 14, wherein the inner lining has a thickness from 1.5 mm to 1 cm.

Aspect 16 is the pipe of Aspect 14 or 15, wherein the pipe comprises at least two openings and wherein:
i) a flange is secured to one opening of the at least two openings; and/or
ii) the pipe forms a flange.

Aspect 17 is the pipe of Aspect 16, wherein the inner lining forms a protrusion ring at the flange, wherein the protrusion ring comprises a terminal portion of the inner lining that coats and/or contacts at least partially a surface of the flange.

Aspect 18 is the pipe of Aspect 17, wherein the pipe further comprises a retainer ring outside the protrusion ring in a concentric manner, wherein the retainer ring is made of a different material than the inner lining.

Aspect 19 is the pipe of any one of Aspects 14 to 18, wherein at least one segment of the pipe is curved.

Aspect 20 is the pipe of any one of Aspects 14 to 19, wherein the pipe has a diameter from about 0.6 to 107 cm.

Aspect 21 is the method of any one of Aspects 1 to 12, wherein the carbon steel pipe is the pipe of any one of Aspects 14 to 20.

Aspect 22 is the system of Aspect 13, wherein the pipe is the pipe of any one of Aspects 14 to 20.

Aspect 23 is the method of any one of Aspects 1 to 12, wherein the method uses the system of any one of Aspects 13 or 22.

The term “connected” is defined as coupled, although not necessarily directly, and not necessarily mechanically; two items that are “connected” may be unitary with each other.

The terms “a” and “an” are defined as one or more unless this disclosure explicitly requires otherwise.

The term “and/or” means “and” or “or”. To illustrate, A, B, and/or C includes: A alone, B alone, C alone, a combination of A and B, a combination of A and C, a combination of B and C, or a combination of A, B, and C.

The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” and “about” may be substituted with “within [a percentage] of” what is specified, where the percentage includes 0.1, 1, 5, and 10 percent.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, an apparatus that “comprises,” “has,” “includes” or “contains” one or more elements possesses those one or more elements, but is not limited to possessing only those elements. Likewise, a method that “comprises,” “has,” “includes” or “contains” one or more steps possesses those one or more steps, but is not limited to possessing only those one or more steps.

Any embodiment of any of the apparatuses, systems, and methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Details associated with the embodiments described above and others are described below.

The foregoing has outlined rather broadly the features and technical advantages of the present disclosure in order that the description of the disclosure may be better understood. Additional features and advantages of the disclosure will be described herein which form the subject of the claims of the disclosure. It should be appreciated by those skilled in the art that the conception and specific aspect disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE FIGURES

For a more complete understanding of the present disclosure, reference is now made to the following descriptions taken in conjunction with the accompanying drawing, in which:

FIG. 1 depicts a schematic view for an exemplary embodiment of a carbon steel pipe (an elbow pipe) with an inner lining of ETFE, with a flange connection.

FIG. 2 depicts a cross-section view for an exemplary embodiment of a carbon steel pipe with an inner lining of ETFE, with a flange connection.

FIG. 3 depicts an exemplary embodiment of dimensions of a flange.

FIG. 4 depicts an exemplary embodiment of a carbon steel pipe with an inner lining of ETFE in the form of a hybrid spool (or carbon steel elbow).

FIG. 5A depicts an exemplary embodiment of a carbon steel pipe with an inner lining of ETFE in the form of a hybrid spool (or carbon steel elbow), which is installed in a SWRO pilot plant unit (indicated by the arrow). FIG. 5B depicts a close-up view of the exemplary hybrid spool shown in FIG. 5A.

FIG. 6A depicts an engineering drawing for an exemplary embodiment of a portable SWRO plant. FIG. 6B depicts an exemplary embodiment of pipelines with hybrid pipes that may be installed and tested in the portable SWRO plant of FIG. 6A.

It should be understood that the drawings are not necessarily to scale and that the disclosed aspects are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular aspects illustrated herein.

### DETAILED DESCRIPTION

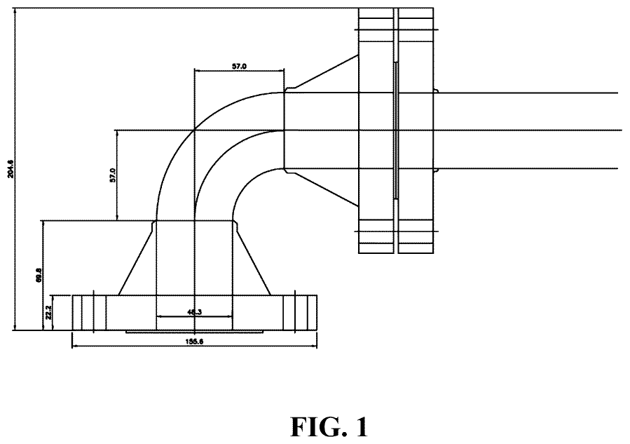

Referring now to the drawings, and more particularly to FIG. 1, which depicts a schematic view for an exemplary embodiment of a carbon steel pipe (an elbow pipe) with an inner lining of ETFE, with a flange connection. The carbon steel elbow has a diameter of about 3.8 cm with class #600.The carbon steel elbow pipe has a curved segment. The carbon steel elbow pipe has two openings, with two flanges at both openings, respectively. One flange of the carbon steel elbow pipe is connected with a flange of another pipe, forming a flange connection.

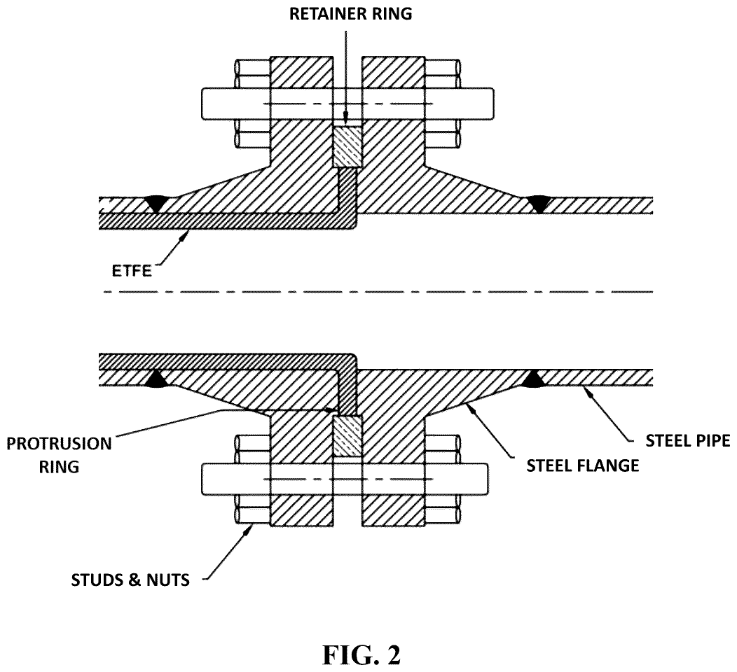

FIG. 2 depicts a cross-section view for an exemplary embodiment of a carbon steel pipe with an inner lining of ETFE, with a flange connection. The inner lining of ETFE coats and/or contacts an inner surface of the carbon steel pipe. The inner lining of ETFE may have a thickness from 3.5 mm to 5 mm. The carbon steel pipe has a straight segment. The carbon steel pipe includes two openings, where a flange is secured to one of the two openings, or where the carbon steel pipe forms a flange at one of the two openings. As shown in FIG. 2, the inner lining of ETFE forms a protrusion ring at the flange, where the protrusion ring comprises a terminal portion of the inner lining that coats and/or contacts at least partially a surface of the flange. The carbon steel pipe further comprises a retainer ring outside the protrusion ring in a concentric manner, where the retainer ring is made of a different material than the inner lining, such as carbon steel. The carbon steel pipe may have a diameter of about 3.8 cm with class #600. The flange of the carbon steel pipe is connected with another steel flange of another steel pipe that does not have an inner lining of ETFE. The two flanges are secured together by studs and nuts. The carbon steel pipe, with an inner lining of ETFE, may transmit a fluid with 3 wt. % to 10 wt. % chloride, at a pH of 5-6, under a pressure of 7 MPa or above. The carbon steel pipe may withstand hoop stress generated by the high-pressure fluid.

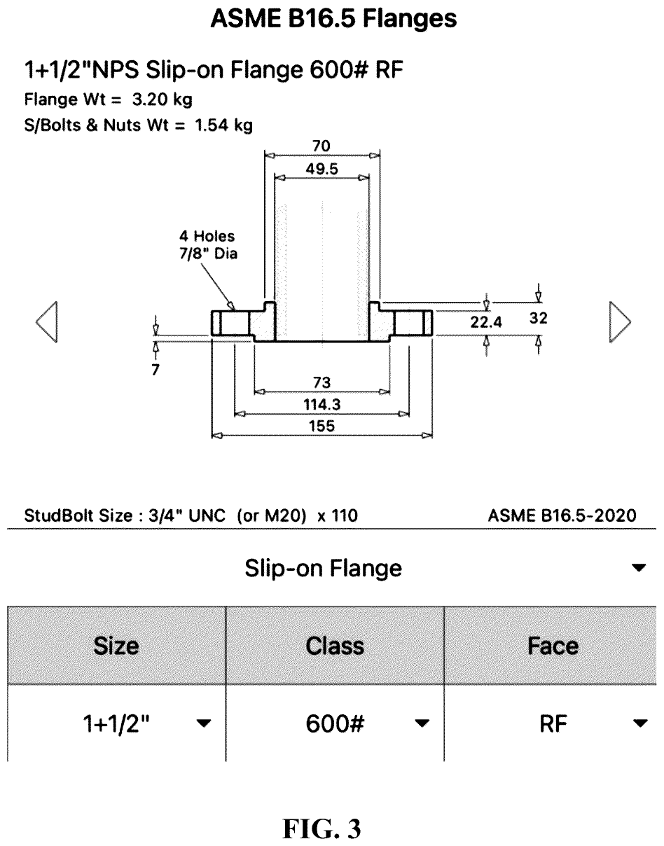

FIG. 3 depicts an exemplary embodiment of dimensions of a flange. An ASME B16.5 flange may be used in this disclosure, which may be a slip-on flange with a size (diameter) of about 3.8 cm, class #600, and RF face.

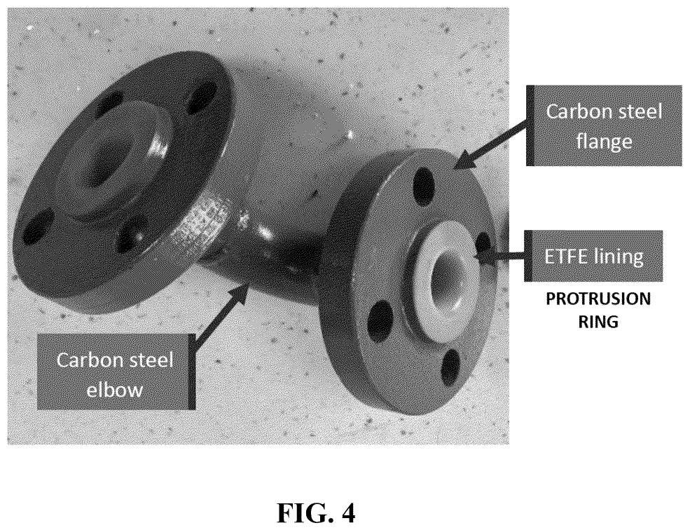

FIG. 4 depicts an exemplary embodiment of a carbon steel pipe with an inner lining of ETFE in the form of a hybrid spool (or carbon steel elbow). The metal part of the hybrid spool is made of carbon steel. The hybrid spool has an inner lining of non-metal ETFE material coating inner surface of the hybrid spool. The hybrid spool has two openings. Each opening of the hybrid spool has a carbon steel flange that is secured to the hybrid spool (e.g., via welding). At each flange, the ETFE inner lining forms a protrusion ring, where the protrusion ring comprises a terminal portion of the inner lining that coats and/or contacts at least partially a surface of the flange. A retainer ring described in FIG. 2 above is not shown in FIG. 4.

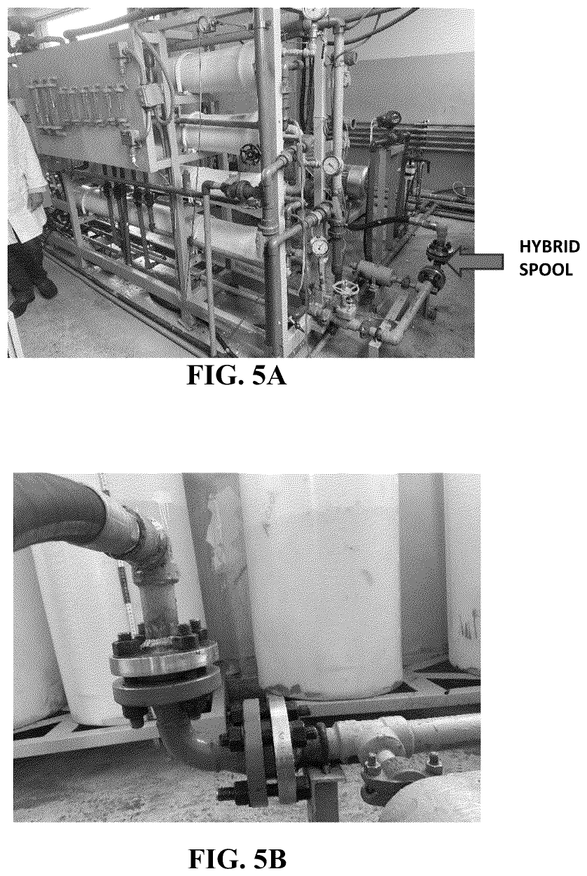

FIG. 5A depicts an exemplary embodiment of a carbon steel pipe with an inner lining of ETFE in the form of a hybrid spool (or carbon steel elbow), which is installed in a SWRO pilot plant unit (indicated by the arrow). The hybrid spool is integrated as a part of the existing fluid lines of the plant. FIG. 5B depicts a close-up view of the exemplary hybrid spool shown in FIG. 5A. The hybrid spool is connected into the existing fluid lines via flange connections, secured by studs and nuts.

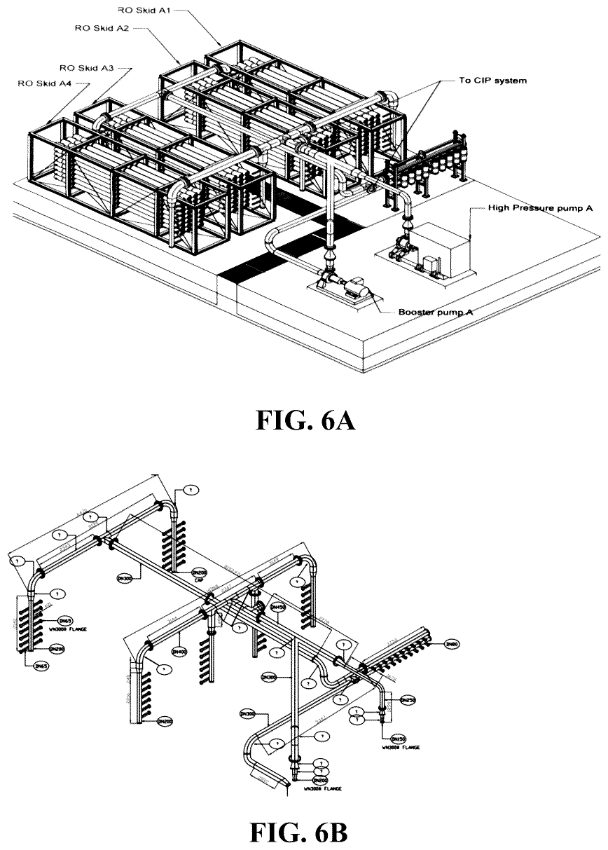

FIG. 6A depicts an engineering drawing for an exemplary embodiment of a portable SWRO plant. FIG. 6B depicts an exemplary embodiment of pipelines with hybrid pipes that may be installed and tested in the portable SWRO plant of FIG. 6A. The portable SWRO plant may have a 20 minimal liquid discharge (MLD) capacity. All the pipelines shown in FIG. 6B may be hybrid pipes with carbon steel and an inner lining of polyethylene (PE).

Any of the pipes in any of the FIGs above with an inner lining of either ETFE or PE may be used to transmit a fluid with 3 wt. % to 10 wt. % chloride, at a pH of 5-6, under a pressure of 7 MPa or above. The fluid may contact the inner lining of the pipes.

### EXAMPLES

The following examples are included to demonstrate exemplary embodiments of the invention. It should be appreciated by those of skill in the art that the techniques disclosed in the examples which follow represent techniques discovered by the inventor to function well in the practice of the invention, and thus can be considered to constitute exemplary modes for its practice. However, those of skill in the art should, in light of the present disclosure, appreciate that many changes can be made in the specific embodiments which are disclosed and still obtain a like or similar result without departing from the spirit and scope of the invention.

### Example 1—Hybrid Spool

Hybrid pipes (e.g., carbon steel pipelines with an inner lining of ETFE or PE) disclosed herein were tested to evaluate their performance and resistance against corrosion, erosion, and high pressure.

Two polymer materials were selected for the inner lining of carbon steel pipes: a) aqueous and chemical corrosion resistant, Ethylene Tetrafluoro Ethylene (ETFE); b) aqueous and corrosion resistant, Polyethylene (PE).

ETFE lined spool. About 3.8 cm diameter #600 carbon steel elbow (FIG. 1) with flange joints (FIGS. 2 and 3) was internally lined with ETFE (FIG. 4) to form a hybrid spool. The hybrid spool was installed in a SWRO pilot plant unit (FIGS. 5A and 5B) and tested for six months under the following conditions:
a) Medium: Seawater
b) Pressure: 7 MPa max.
c) Temperature: Ambient

Qualitative and Quantitative Examinations of ETFE Lining of the Hybrid Spool. The test was completed after six months of continuous flow of seawater. After the test, ETFE lining was visually examined for its integrity. After visual examinations, ETFE lining was removed and physical and mechanical properties were measured. Measured values were compared with the standard properties of this material. Results are provided in TABLE 1.

TABLE 1
Property Evaluation and Visual Examination
of ETFE Lining of the Hybrid Spool.

| | | | | Standard | Measured |
|---|---|---|---|---|---|
| | | | | values | values |
| S. | | Test | | (Before | (After |
| No | Tests | Standard | Unit | test) | test) |
| 1 | Tensile strength¹ | ATM D638 | MPa | 36.5 | 42.06 |
| 2 | Elongation @ break¹ | ISO 527 | % | 350 | 393.42 |
| 3 | Melting point | D 3418 | ° C. | 253 | 259.48 |
| 4 | Specific Gravity | D 792 | % | 1.72 | 1.73 |
| 5 | Bulk Density | ASTM | g/cm³ | 1.74 | 1.73 |
| | | D1505 | | | |

¹Test specimen according to ISO 527-2 type 1 BA, thickness 2 mm with 50 mm/min test speed.

Results shown in TABLE 1 did not indicate remarkable change in the physical and mechanical properties of ETFE material. These results confirm stability of ETFE material in seawater under SWRO operation conditions.

### Example 2—Portable SWRO Plant Test

Polyethylene (PE) lined hybrid pipes may be tested for the construction of a portable SWRO plant having a 20 MLD capacity. The drawing of the portable SWRO plant is shown in FIG. 6A. In this portable SWRO plant, all the pipelines shown in FIG. 6B may be PE/carbon steel hybrid in nature (e.g., carbon steel pipes with an inner lining of PE). During this test all the properties mentioned in TABLE 1 may be measured before and after the test. Additionally, to ensure good quality of the product water, periodic chemical analyses may also be carried out during the operation of this plant. It is expected that the PE lined hybrid pipes will not show remarkable change in the physical and mechanical properties of the PE material.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the devices are not intended to be limited to the particular forms disclosed. Rather, they include all modifications and alternatives falling within the scope of the claims, and embodiments other than the one shown may include some or all of the features of the depicted embodiment. For example, components may be omitted or combined as a unitary structure, and/or connections may be substituted. Further, where appropriate, aspects of any of the examples described above may be combined with aspects of any of the other examples described to form further examples having comparable or different properties and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

What is claimed is:

1. A method for transporting an aqueous solution, the method comprising contacting an aqueous solution comprising 3 wt. % or more chloride with an inner lining of a carbon steel pipe, the inner lining comprising ethylene tetrafluoro ethylene polymer or a polyethylene polymer and the inner lining coating an inner surface of the carbon steel pipe.

2. The method of claim 1, wherein the aqueous solution comprises 3 wt. % to 20 wt. % chloride.

3. The method of claim 1, wherein the aqueous solution is acidic.

4. The method of claim 3, wherein the aqueous solution has a pH from 3 to 6.9.

5. The method of claim 1, wherein the aqueous solution has a pressure of 4 MPa or above.

6. The method of claim 1, wherein the aqueous solution comprises seawater or brackish water that comprises or has been treated to comprise 3 wt. % or more chloride.

7. The method of claim 1, wherein the inner lining has a thickness from 1.5 mm to 1 cm.

8. The method of claim 1, wherein the carbon steel pipe comprises at least two openings and wherein:
i) a flange is secured to one opening of the at least two openings; and/or
ii) the carbon steel pipe forms a flange.

9. The method of claim 8, wherein the inner lining forms a protrusion ring at the flange, wherein the protrusion ring comprises a terminal portion of the inner lining that coats and/or contacts at least partially a surface of the flange.

10. The method of claim 9, wherein the carbon steel pipe further comprises a retainer ring outside the protrusion ring in a concentric manner, wherein the retainer ring is made of a different material than the inner lining.

11. The method of claim 1, wherein at least one segment of the carbon steel pipe is curved.

12. The method of claim 1, wherein the carbon steel pipe has a diameter from about 0.6 to 107 cm.

13. A system for transporting an aqueous solution, the system comprising:
a pipe comprising carbon steel and an inner lining coating an inner surface of the pipe, the inner lining comprising ethylene tetrafluoro ethylene polymer or a polyethylene polymer; and
a source of the aqueous solution comprising 3 wt. % or more chloride, the source being in fluid communication with the pipe.

14. A pipe for transporting an aqueous solution comprising 3 wt. % or more chloride, the pipe comprising carbon steel and an inner lining coating an inner surface of the pipe, the inner lining comprising ethylene tetrafluoro ethylene polymer or a polyethylene polymer.

15. The pipe of claim 14, wherein the inner lining has a thickness from 1.5 mm to 1 cm.

16. The pipe of claim 14, wherein the pipe comprises at least two openings and wherein:
i) a flange is secured to one opening of the at least two openings; and/or
ii) the pipe forms a flange.

17. The pipe of claim 16, wherein the inner lining forms a protrusion ring at the flange, wherein the protrusion ring comprises a terminal portion of the inner lining that coats and/or contacts at least partially a surface of the flange.

18. The pipe of claim 17, wherein the pipe further comprises a retainer ring outside the protrusion ring in a concentric manner, wherein the retainer ring is made of a different material than the inner lining.

19. The pipe of claim 14, wherein at least one segment of the pipe is curved.

20. The pipe of claim 14, wherein the pipe has a diameter from about 0.6 to 107 cm.
